(19) United States
(12) Patent Application Publication
(10) Pub. No.: US 2024/0347036 A1
(43) Pub. Date: Oct. 17, 2024

(54) PSEUDOTELEPATHY HEADSET

(71) Applicant: University of Utah Research Foundation, Salt Lake City, UT (US)

(72) Inventors: Nicholas S. WITHAM, Salt Lake City, UT (US); Juan Pablo BOTERO TORRES, Salt Lake City, UT (US); Colleen CHEMERKA, Salt Lake City, UT (US); Tanner KRONE, Salt Lake City, UT (US); Rami SHORTI, Salt Lake City, UT (US); Thomas ODELL, Salt Lake City, UT (US)

(21) Appl. No.: 18/638,155

(22) Filed: Apr. 17, 2024

Related U.S. Application Data
(60) Provisional application No. 63/496,492, filed on Apr. 17, 2023.

(51) Int. Cl. G10L 13/04; G06F 3/01

(52) U.S. Cl. CPC G10L 13/04; G06F 3/012

(57) ABSTRACT

A system for enabling conversion of speech pantomimes of a user into synthesized speech includes a headset connected to an artificial intelligence network hosted on a computing device. The headset can include an array of distance measurement devices distributed adjacent facial regions of the user associated with speech. The system can further include a microphone and a speaker. Sensor data captured by the distance measuring devices and audio data captured by the microphone are used to train the artificial intelligence network to correlate speech pantomimes of the user with phonemes. The system can output synthesized speech generated from the phonemes through the speaker.

### CROSS REFERENCE TO RELATED APPLICATIONS

This application claims the benefit of U.S. Provisional Patent Application No. 63/496,492 filed on Apr. 17, 2023 and entitled “Pseudotelepathy Headset”, which is incorporated by reference in its entirety.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION BY REFERENCE STATEMENT

Not applicable.

### BACKGROUND

People with severe speech and/or voice disorders need the ability to communicate verbally with those around them. Current solutions include augmentative and alternative communication devices, speech-generating devices (SGDs), eyetracking and text-to-speech software, Electrolarynx EMG, and subvocalization decoding headsets. Current Augmentative and Alternative Communication (AAC) devices are slow, cumbersome, and do not sound like a natural voice. Further, EMG subvocalization decoding headsets tend to be inaccurate, have a limited vocabulary, require burdensome training, and have no voice output.

### SUMMARY

A pseudotelepathy headset can include an array of distance measuring devices. Each of the distance measuring devices can include a light emitter and a light sensor. The distance measuring devices are positioned and oriented above facial regions or muscles associated with speech when the headset is worn by a user. The distance measuring devices continuously monitor and output distance data associated with a distance between the devices and the monitored facial regions of the user. The headset can further include a microphone for capturing vocalizations by a user. The microphone outputs audio data synchronized with the distance data.

The distance data and the audio data provided by the headset can be used to train an artificial intelligence network hosted on a computing device. In particular, the artificial intelligence network can be trained using the distance data and the audio data to correlate facial movements associated with speech with the most likely phonemes intended by the user. When fully trained, the artificial intelligence network can output the most probable phonemes determined from the speech pantomimes of the user. The phonemes generated by the artificial intelligence network can be used to generate text and/or synthesized speech. Built in speakers or bone-conducting headphones can allow the user to “talk” to others and/or hear his or her own synthesized voice despite a severe speech impediment.

There has thus been outlined, rather broadly, the more important features of the invention so that the detailed description thereof that follows can be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a diagram of an exemplary system for converting speech pantomimes of a user into synthesized speech using an artificial intelligence network according to some embodiments.

FIG. 2 illustrates an exemplary headset for use with an artificial intelligence network according to some embodiments.

FIG. 3 illustrates an exemplary earpiece of the headset shown in FIG. 2 according to some embodiments.

FIG. 4 illustrates an exemplary support member of the headset shown in FIG. 2 according to some embodiments.

FIG. 5 illustrates an exemplary support member of the headset shown in FIG. 2 according to some embodiments.

FIG. 6 illustrates an exemplary support member of the headset shown in FIG. 2 according to some embodiments.

FIG. 7 illustrates a front of an exemplary circuit board for a distance measuring device of the headset shown in FIG. 2 according to some embodiments.

FIG. 8 illustrates a back of an exemplary circuit board for a distance measuring device of the headset shown in FIG. 2 according to some embodiments.

FIG. 9 illustrates a graph of an output of a distance measuring device according to some embodiments.

FIG. 10 illustrates a graph of an output of a distance measuring device according to some embodiments.

FIG. 11 illustrates a block diagram of an exemplary computing device for operating an artificial intelligence network according to some embodiments.

FIG. 12 illustrates exemplary phonetic pangrams for training an artificial intelligence network according to some embodiments.

FIG. 13 illustrates exemplary Harvard phrases for training an artificial intelligence network according to some embodiments.

FIG. 14 illustrates exemplary phonemes for training an artificial intelligence network according to some embodiments.

FIG. 15 illustrates a method of converting speech pantomimes of a user into synthesized speech using a artificial intelligence network according to some embodiments.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “a sensor” includes reference to one or more of such devices and reference to “collecting” refers to one or more of such actions.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, or combinations of each.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Example Embodiments

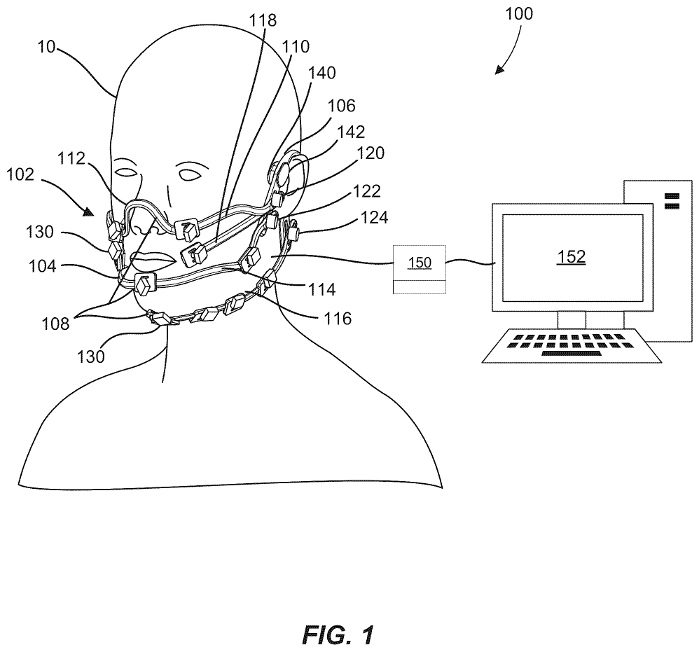

Referring to FIG. 1, there is depicted a system 100 for generating synthesized speech based on facial movements made as a user 10 expresses words, e.g. with or without audible noise. The system 100 includes a headset 102 worn by the user 10. The headset 102 can include a headset frame 104 having a pair of earpieces 106 (only one visible in FIG. 1) and a front frame portion 108. The earpieces 106 can support the headset 102 on the user 10. The front frame portion 108 can extend between the pair of earpieces 106. That is, the front frame portion 108 can extend across the face of the user 10. That is, the front frame portion 108 can be positioned over the portions of the face of the user 10 that typically move when the user 10 speaks.

The front frame portion 108 can include a first support member 110 having a nose piece 112, a second support member 114, and a third support member 116. The front frame portion 108 can further include a pair of cantilevered support members 118 (only one visible in FIG. 1). Opposing ends of the first support member 110 can be attached to the earpieces 106 by fasteners 120. Opposing ends of the second support member 114 can be attached to the earpieces 106 by fasteners 122. Opposing ends of the third support member 116 can be attached to the earpieces 106 by fasteners 124. One end of each of the cantilevered support members 118 can be attached to, and extend from, the first support member 110.

The first support member 110 can extend across an upper portion of the face of the user 10 with the nose piece 112 passing over the bridge of the nose of the user 10. The second support member 114 can extend across the region between the chin and mouth of the user 10. The third support member 116 can extend along the jaw of the user 10 and under the chin of the user 10. The cantilevered support members 118 can extend towards the corners of the mouth of the user 10.

An array of distance measuring devices 130 can be supported by the front frame portion 108. The front frame portion 108 orients the distance measuring devices 130 adjacent facial muscles or facial regions of the user 10 associated with speech. The distance measuring devices 130 can be positioned above the face of the user 10 by a distance of up to 2 centimeters, or more. To be clear, the distance measuring devices 130 can be held above the face of the user 10 by the headset 102.

Although depicted in this example as having support members extending around a front portion of a user's face, one or more support members can extend around a rear portion and/or an upper portion of the head such that cantilevered or additional support members can orient distance measuring devices over corresponding facial muscles and regions.

The front frame portion 108 can position the distance measuring devices 130 on both sides or only one side of the face of the user 10. In an embodiment, the first support member 110 can position a distance measuring device 130 on either side of the nose of the user 10. In an embodiment, the second support member 114 can position a distance measuring device 130 over each check of the user 10 and one in the region between the mouth and chin of the user 10. In an embodiment, the third support member 116 can position distance measuring devices 130 along the jawline and under the chin of the user 10. In an embodiment, each cantilevered support member 118 can position a distance measuring device 130 near a corner of the mouth of the user 10. It will be appreciated that other distributions of the distance measuring devices 130 over the face of the user 10 can be suitable. In an embodiment, the array can comprise two, three, four, five, six, seven, eight, nine, ten, eleven, twelve, thirteen, fourteen, fifteen, sixteen, or more distance measuring devices. In an embodiment, the headset 102 can have one or more distance measuring devices 130. In some cases, one or more distance measuring devices can be distributed over the face and adjacent one or more of the following facial regions: infraorbital, oral, buccal, mental, zygomatic, parotidcomasseteric, and auricular. In one example, at least one distance measuring device can be oriented adjacent each of the facial regions.

Each distance measuring device 130 can continuously sample a distance to a monitored facial region of the user 10. In an embodiment, the distance measuring devices 130 can use various optical processes for determining the distances to monitored facial regions of the user 10. For example, a distance measuring device 130 can comprise a light emitter and an associated light sensor. In an embodiment, the light emitter can emit light and its associated light sensor can detect light reflected off the monitored facial region of the user 10. In an embodiment, the light sensor detects the reflected light and converts it into an electrical signal. The distance measuring device 130, or the system 100, can use the intensity of the electrical signal to determine the distance to the monitored facial region. In an embodiment, the calculated distance, or the intensity, is converted into a usable format, such as voltage, current, or a digital signal, which can be read by a microcontroller or other electronic device. The light emitters can emit a visible light, infrared light or the like. In one example, the light emitters can emit infrared light.

In another embodiment, the light emitter can emit short bursts of light towards the monitored facial region and the light sensor can detect the reflected light. As a general guideline, these short bursts can range from 5 msec to 1 sec, and often from 10 msec to 500 msec. The distance measuring device 130, or the system 100, can measure the time it takes for the emitted light pulse to travel to the monitored facial region and back to the light sensor. This time measurement can be directly related to the distance to the monitored facial region. For example, using the known speed of light, a distance measuring device 130, or the system 100, can calculate the distance to the monitored facial region based on the time it took for the light pulse to travel from the light emitter and back to the light sensor. In an embodiment, the calculated distance, or the time of flight, is converted into a usable format, such as voltage, current, or a digital signal, which can be read by a microcontroller or other electronic device. In an embodiment, the distance measuring devices 130 can continuously sample distances to the monitored facial regions while the user 10 speaks or pantomimes speech. As a general guideline, such distance measuring devices can provide an accuracy of about 0.5 μm to about 100 μm, and in some cases 1 μm to 50 μm.

In an embodiment, the headset 102 can further include a microphone 140 and a speaker 142. In an embodiment, the microphone 140 is a bone conduction microphone. In an embodiment, the speaker 142 is a bone conduction speaker. In an embodiment, each distance measuring device 130 can be connected to a controller 150. The controller 150 can provide a power supply (VCC) and a ground (GND) to each of the distance measuring devices 130. In addition, the controller 150 can be connected to an output of each of the distance measuring devices 130 in order to receive sensor data. The controller 150 can also be connected to the microphone 140 in order to receive audio data. The controller 150 can also be connected to the speaker 142 to output audio data. It will be appreciated that the connections between the controller 150 and the distance measuring devices 130 and the microphone 140 can be wired or wireless, except of course for the VCC and GND connections. A wirelessly charged power source or storage battery can also be used.

In an embodiment, the controller 150 can be connected to an artificial intelligence network hosted by a computing device 152 by either a wired or wireless connection. The artificial intelligence network can be based on neural networks, machine learning, deep learning, adaptive algorithm, or the like. The computing device 152 can comprise, for example, any processor-based system. The computing device 152 can be one or more devices such as, but not limited to, desktop computers, laptops or notebook computers, tablet computers, mobile devices, smart phones, mainframe computer systems, handheld computers, workstations, network computers, servers, cloud-based devices, or other devices with like capability. In addition, the computing device 152 can comprise one or more computing devices.

As will be explained in more detail below, the controller 150 can provide sensor data from the distance measurement devices 130 and audio data from the microphone 140 to the computing device 152. In a training mode, the computing device 152 can use the sensor data and the audio data to train the artificial intelligence network to correlate facial movements of the user 10 with phonemes. The computing device 152 can then use the artificial intelligence network, once trained, to generate phonemes based on pantomimes of speech (silent speech) by the user 10. The computing device 152 can then convert the phonemes to synthesized speech. The synthesized speech can be output by the system 100 using the speaker 142.

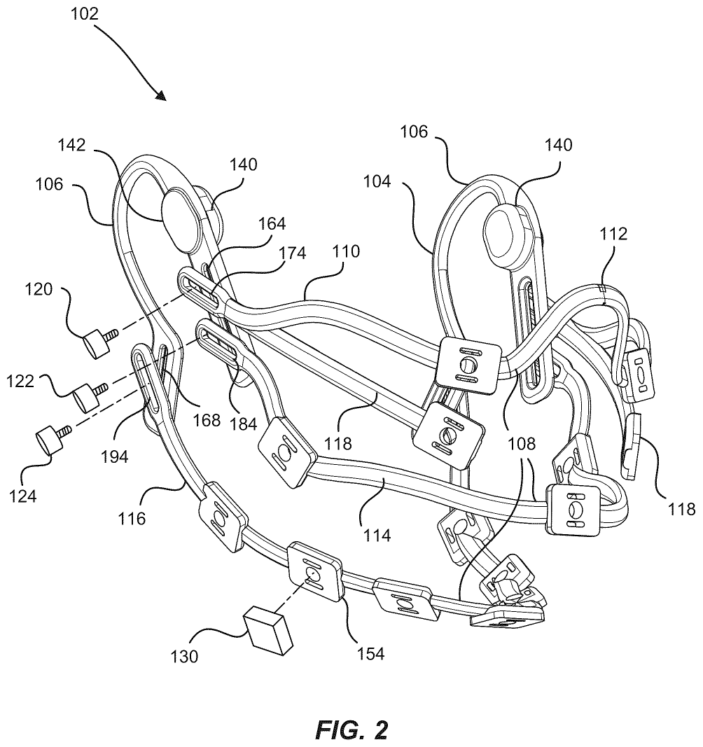

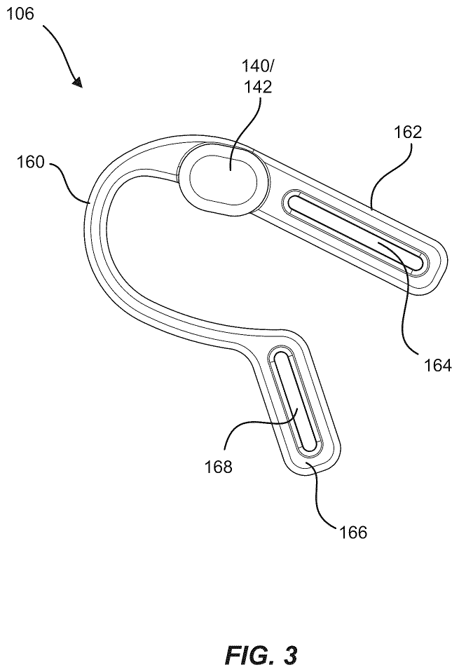

Referring to FIGS. 2 and 3, reference will now be made to one of the earpieces 106 with the understanding that it applies to both earpieces 106. The microphone 140 and the speaker 142 are supported by a curved body portion 160 of the earpiece 106. A first end 162 of the curved body portion 160 can include an elongated slot 164. A second end 166 of the curved body portion 160 can also include an elongated slot 168. The elongated slot 164 and the elongated slot 168 are used to mount the components of the front frame portion 108 of the headset 102.

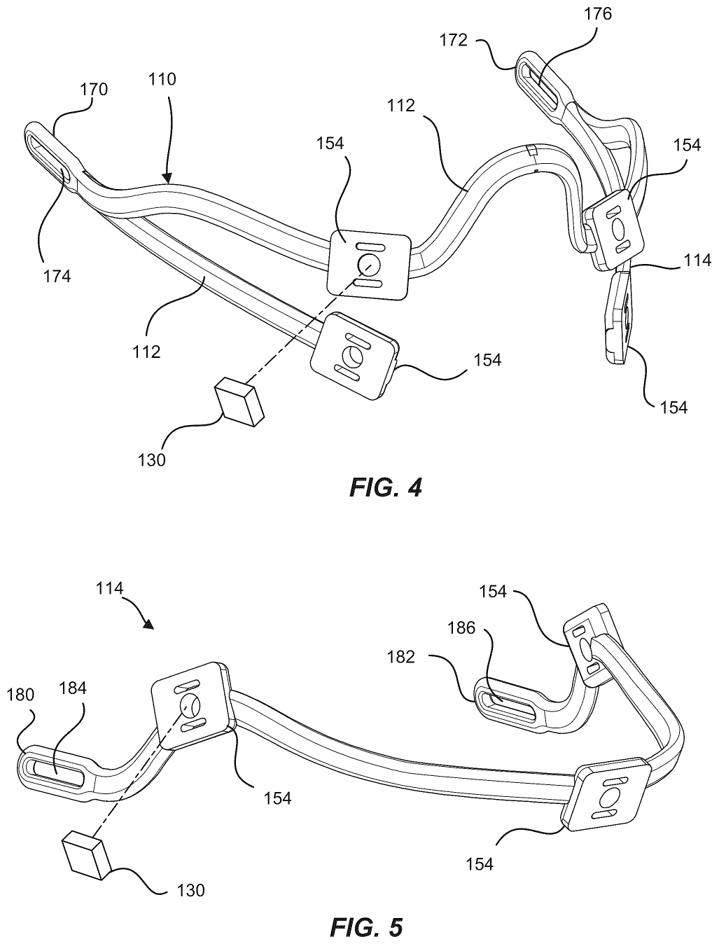

Referring to FIGS. 2 and 4, the first support member 110 can extend between a first end 170 and a second end 172. The first end 170 can include an elongated slot 174. The second end 172 can include an elongated slot 176. Formed on the first support member 110 can be a plurality of mounting locations (MLs) 154 for securing the distance measuring devices 130. The cantilevered support members 118 can extend from the first support member 110. A ML 154 can be disposed on each of the free ends of the cantilevered support members 118.

Referring to FIGS. 2 and 5, the second support member 114 can extend between a first end 180 and a second end 182. The first end 180 can include an elongated slot 184. The second end 182 can include an elongated slot 186. Formed on the second support member 114 can be a plurality of mounting locations (MLs) 154 for securing the distance measuring devices 130.

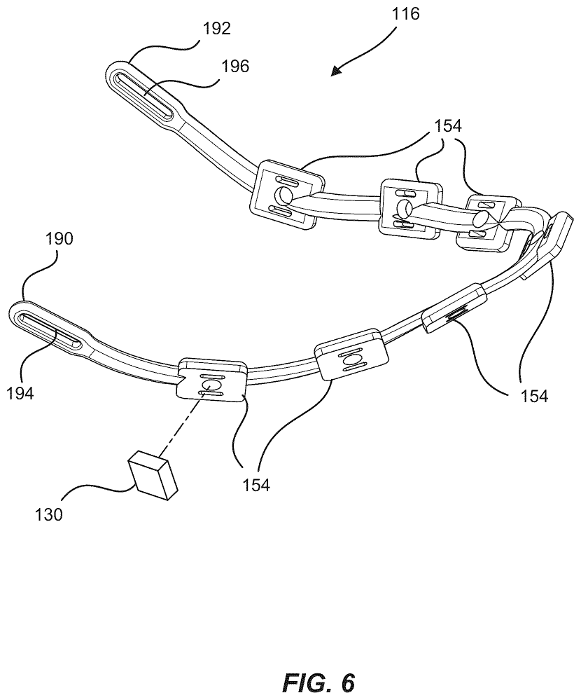

Referring to FIGS. 2 and 6, the third support member 116 can extend between a first end 190 and a second end 192. The first end 190 can include an elongated slot 194. The second end 192 can include an elongated slot 196. Formed on the third support member 116 can be a plurality of mounting locations (MLs) 154 for securing the distance measuring devices 130.

Referring back FIG. 2, assembly of the headset 102 will now be described with reference to the right earpiece 106 with the understanding that the description applies to the left earpiece 106 as well. The first support member 110 can be secured to the right earpiece 106 by aligning the elongated slot 164 with the elongated slot 174. The fastener 120 can be installed to secure the slot 164 and slot 174 together at the desired orientation. The second support member 114 can be secured to the right earpiece 106 by aligning the elongated slot 164 with the elongated slot 184. The fastener 122 can be installed to secure the slot 164 and slot 184 together at the desired orientation. The third support member 116 can be secured to the right earpiece 106 by aligning the elongated slot 168 with the elongated slot 194. The fastener 124 can be installed to secure the slot 168 and slot 194 together at the desired orientation.

Further, the headset 102 is exemplified here as a supported frame. However, other support structures can be used. Non-limiting examples of suitable support structures can include a frame, mesh, helmet, or the like. Additional optional flexible fabric can be secured over a support structure to provide aesthetic protection, temperature regulation, or other purposes.

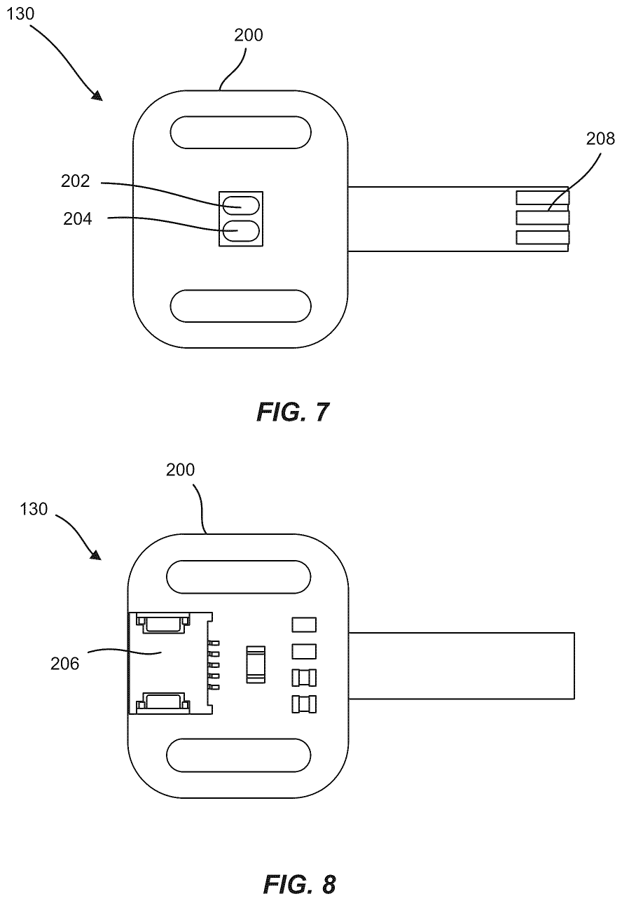

Referring to FIGS. 7 and 8, there is depicted a distance measuring device 130 according to some embodiments. The device 130 can include a circuit board 200 having a light emitter 202 and a light sensor 204 mounted thereon. The light emitter 202 and the light sensor 204 can be integrated into a single unit 206. In an embodiment, the light emitter 202 can emit infrared light and the light sensor 204 can detect infrared light. In an embodiment, the light emitter 202 can emit visible light and the light sensor 204 can detect visible light. In an embodiment, the light emitter 202 can comprise a light emitting diode (LED). In an embodiment, the light emitter 202 can emit incoherent light and the light sensor 204 can detect incoherent light. In an embodiment, the light emitter 202 can emit coherent light and the light sensor 204 can detect coherent light. The circuit board 200 can further include electrical connectors 208 for VCC, GRD, and signal output. In an embodiment, the circuit board 200 can be contained in a housing (not shown). In an embodiment, the housings of the distance measuring devices 130 can be secured to the MLs 154 on the headset 102 in any suitable manner including, but not limited to, snap-fit, straps, screws, hook-and-loop fastener, or adhesive.

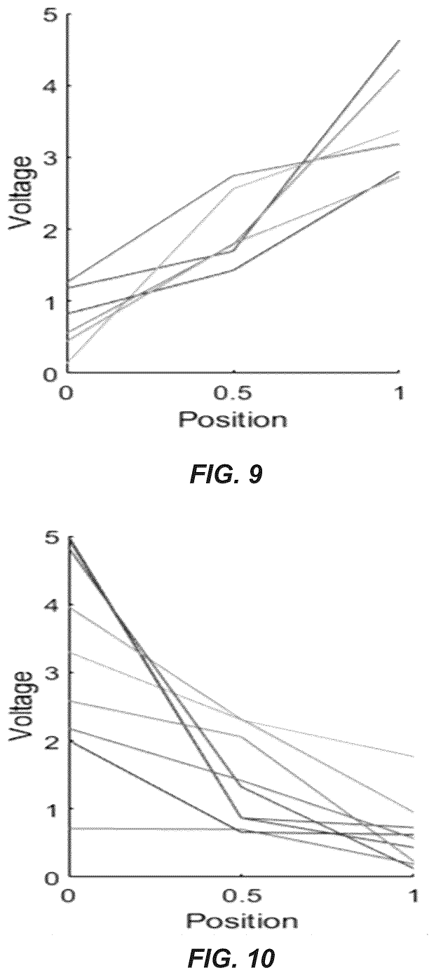

Referring to FIG. 9, there is shown a graph of the voltage output from a distance measuring device 130 in relation to a distance from the light sensor 204 according to some embodiments. Referring to FIG. 10, there is shown a graph of the voltage output from a distance measuring device 130 in relation to a distance from the light sensor 204 according to some embodiments. In this manner, each distance measuring device can have a corresponding set of distance data collected over time which can be input into the algorithm as described in more detail in the following section.

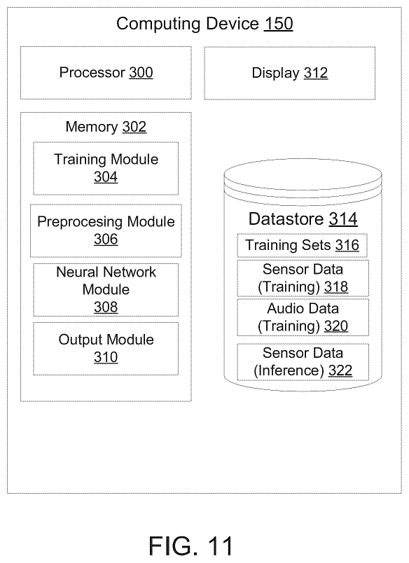

Referring to FIG. 11, the computing device 152 can include a processor 300 and a memory 302. Stored in the memory 302 can be programs, including a training module 304, a preprocessing module 306, an artificial intelligence network 308 and an output module 310. The computing device 152 can further include a display 312. The computing device 152 can further include a datastore 314. The datastore 314 can store training sets 316, sensor data (training) 318, audio data (training) 320, and sensor data (inference) 322.

The training module 304 can be a computer program that is operable to train the artificial intelligence network 308. The training module 304 can utilize the training sets 316, sensor data (training) 318 and audio data (training) 320 to train the artificial intelligence network 308 to correlate speech pantomimes of a user to phonemes. The training sets 316 can include pre-established words, phrases or sounds for a user to repeat during the training phase of the artificial intelligence network. The training sets 316 can be presented to a user on the display 312 for the user to vocalize.

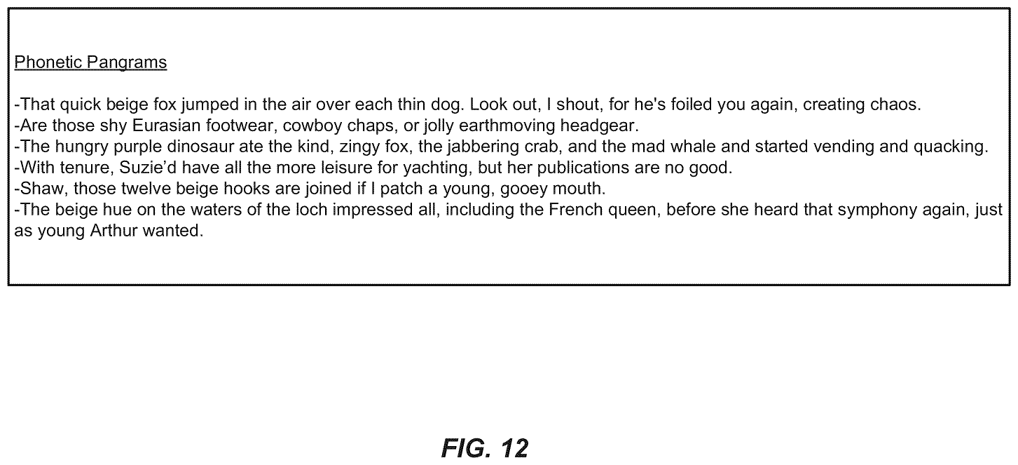

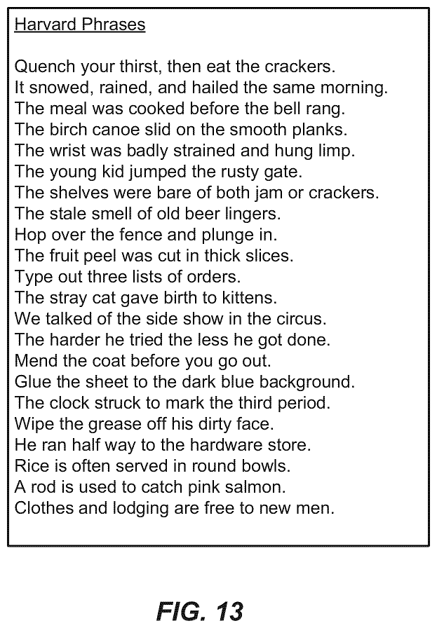

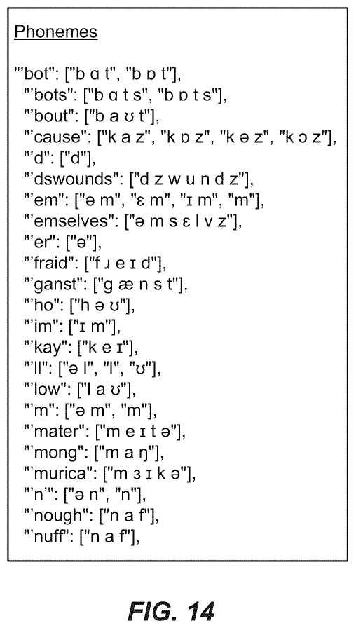

In an embodiment, the training sets 316 can include phonetic pangrams, which are sentences that contain every phoneme (distinct sound) in a language. FIG. 12 illustrates examples of phonetic pangrams for the English language. Of course, similar training sets can be produced for any other language. In an embodiment, the training sets 316 can include Harvard phrases, which are sentences that include all the phonemes of a given language or set of languages. FIG. 13 illustrates examples of Harvard phrases. In an embodiment, the training sets 316 can include phonemes, which are the smallest units of sound in a language that can distinguish one word from another (phonemes are abstract representations of speech sounds). FIG. 14 illustrates examples of English phonemes. It will be appreciated that the present invention is not limited to the phonetic pangrams, phrases and phonemes shown in FIGS. 12-14. Indeed, other training sets can be utilized with the present disclosure.

The preprocessing module 306 prepares the input data before it is fed into the artificial intelligence network 308 for training or inference. In training mode, the input data is the audio data (training) 320 and the sensor data (training), In inference mode, the phase where the trained artificial intelligence network 308 is deployed, the input data is the sensor data (inference) 322 with no audio data (because the user is pantomiming). The output module 310 can output synthesized speech or text.

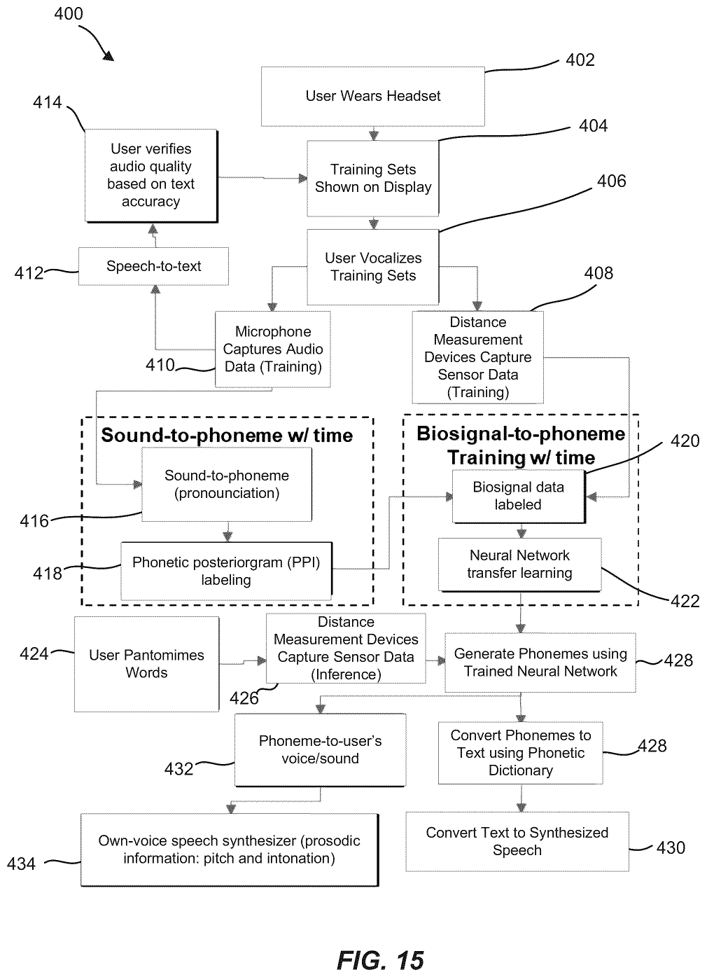

Referring to FIG. 15, a flowchart depicts a process 400 for generating synthesized speech from a user pantomiming words using an artificial intelligence network. At step 402, the user puts on a headset, such as headset 102. The headset many include an array of distance measuring devices, such as distance measuring devices 130. The distance measuring devices are positioned and oriented by the headset adjacent facial regions or muscles of the user associated with speech. Each of the distance measuring devices can include a light emitter and a light sensor. For example, the light emitter can emit infrared light and the light sensor can detect infrared light reflected from the face of the user. The distance measuring devices can output a signal, e.g. a voltage, that indicates a distance to the adjacent facial regions or muscles of the user that are associated with speech. In an embodiment, the distance measuring devices can continuously sample the distance in order to detect and track facial movements associated with speech.

In an embodiment, the array of distance measuring devices can be distributed across the entire face, half of the face, or a portion of the face of the user. In an embodiment, the array can comprise two, three, four, five, six, seven, eight, nine, ten, eleven, twelve, thirteen, fourteen, fifteen, sixteen, or more distance measuring devices. The headset can further include a microphone and a speaker, such as microphone 140 and speaker 142. In an embodiment, the microphone and speaker each use bone conduction. The headset can be connected to a controller, such as controller 150. The controller can be connected to a artificial intelligence network hosted on a computing device, such as the artificial intelligence network 308 residing on the computing device 152.

At step 404, training sets are displayed to the user on a display, such as display 312. The training sets can comprise words, phrases and sounds. For example, the training sets can comprise phonemes, Harvard phrases, and phonetic pangrams, such as those shown in FIGS. 12-14. At step 406, the user vocalizes the training sets shown on the display. At step 408, the distance measurement devices on the headset capture sensor data as the user vocalizes the training sets. The sensor data can include multiple channels that correlate to a distance between the distance measurement devices and the facial regions or muscles of the user associated with speech. At step 410, the microphone captures audio data (training) simultaneously as the distance measurement devices capture the sensor data (training).

The process 400 can optionally include a feedback loop. At step 412, the audio data (training) is converted to text using an output module, such as output module 310. At step 414, the text is displayed to the user on the display so that the user can verify the audio quality based on text accuracy.

At step 416, the sound waves in the captured audio data (training) are used to generate phonemes. That is, a sequence of sound waves represented by the audio data (training) are converted into a sequence of phonemes. At step 418, a phonetic posteriorgram is generated. The phonetic posteriorgram can be a representation of the probability distribution of phonemes given an input acoustic signal. At step 420, the phonemes are correlated with the sensor data (training) to create labeled biosignal data. At step 422, the labeled biosignal data is used to train the artificial intelligence network. It will be appreciated that the steps 416-422 can be performed by a training module, such as training module 304, during a training phase of the artificial intelligence network.

The remaining steps represent an inference mode of the artificial intelligence network. At step 424, once the artificial intelligence network has been trained, the process 400 can be used to generate phonemes, text, words, or synthesized speech from speech expressions of the user. As used herein, speech expressions can refer to the user silently mouthing words. At step 426, as the user expressions words, the distance measurement devices capture sensor data (inference). The distance measurement devices can continuously sample the distance in order to capture complete facial movements associated with phenomes and speech. At step 428, the sensor data (inference) is provided to the trained artificial intelligence network. The trained artificial intelligence network can generate and output the most likely phonemes based on the captured sensor data (inference). At step 430, the phonemes generated by the artificial intelligence network can be converted to words or text using a phonetic dictionary. At step 430, the words or text can be converted to synthesized speech by a text-to-speech program.

Alternatively, at step 432, the phonemes generated by the artificial intelligence network at step 428 can be converted to a voice or sound matching the user's own voice. At step 434, synthesize speech matching the pitch and intonation of the user can be generated. It will be appreciated that the steps 428-434 can be performed by an output module, such as output module 310 of the computing device 152. The synthesized speech can be output to a speaker, such as speaker 142. Notably, this system produces phonemes based on the user's expressions rather than attempting to discern or reproduce specific words. In other words, the system does not reconstruct whole words per se, but rather the foundational phonemes and the particular intonation and expression of those phonemes by the user.

These adaptive artificial intelligence models can also be adjusted over time based on changes in user preferences, increased vocabulary, varied dialect, maturing intonations (e.g. child growing to an adolescent, to an adult, or to an elderly user), or other variables.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, a non-transitory machine-readable storage medium, such as RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A headset, comprising:
a headset frame adapted to be worn on a head of a user, the headset frame having a front frame portion; and
an array of distance measurement devices distributed across the front frame portion of the headset frame;
wherein the array of distance measurement devices are oriented adjacent facial regions of the user associated with speech when the headset frame is worn by the user.

2. The headset of claim 1, wherein each of the distance measurement devices comprises a light emitter and an associated light sensor.

3. The headset of claim 2, wherein each light emitter emits infrared light and its associated light sensor detects infrared light.

4. The headset of claim 3, wherein each light sensor outputs a signal responsive to detected infrared light.

5. The headset of claim 2, wherein each light emitter is a light emitting diode (LED).

6. The headset of claim 2, wherein each light emitter emits incoherent light.

7. The headset of claim 1, wherein the headset frame comprises a first ear piece and a second earpiece, wherein the front frame portion extends between the first ear piece and the second earpiece.

8. The headset of claim 7, wherein the front frame portion comprises a first support member having a nose bridge.

9. The headset of claim 8, wherein the front frame portion further comprises a second support member configured to reside adjacent a region between a mouth and a chin of the user when the headset is worn by the user.

10. The headset of claim 9, wherein the front frame portion further comprises a third support bar configured to reside under the chin of the user when the headset is worn by the user.

11. The headset of claim 10, wherein the front frame portion further comprises a first cantilevered member and a second cantilevered member.

12. The headset of claim 1, further comprising a microphone for capturing vocalizations from the user.

13. The headset of claim 12, further comprising a computing device in communication with the distance measurement devices and the microphone, the computing device operable to use data from the distance measurement devices and the microphone to train an artificial intelligence network.

14. A system for enabling conversion of speech pantomimes of a user into synthesized speech, the system comprising:
a headset having a headset frame adapted to secure to a head of the user, the headset frame having a front frame portion and one or more distance measurement devices distributed across the front frame;
a microphone for capturing vocalizations from the user; and
a computing device in communication with the distance measurement devices and the microphone, the computing device programmed to use sensor data from the one or more distance measurement devices and audio data from the microphone to train an artificial intelligence network to correlate speech pantomimes of the user with phonemes.

15. The system of claim 14, further comprising an array of distance measuring devices distributed across the front frame portion.

16. The system of claim 15, further comprising an output module for synthesizing speech from the phonemes generated by the artificial intelligence network.

17. The system of claim 14, wherein each of the one or more distance measurement devices comprises a light emitter and an associated light sensor.

18. The system of claim 17, wherein each light emitter emits infrared light and its associated light sensor detects infrared light.

19. The system of claim 18, wherein each light sensor outputs sensor data responsive to the reflected infrared light.

20. The system of claim 17, wherein each light emitter is a light emitting diode (LED).

21. The system of claim 17, wherein each light emitter emits incoherent light.

22. The system of claim 14, further comprising a display operable to display training sets to the user.

23. A method for enabling conversion of speech pantomimes of a user into synthesized speech, the method comprising:
capturing a first set of sensor data from an array of distance measurement devices distributed across a front frame portion of a headset frame of a headset while the user vocalizes a plurality of training sounds;
capturing audio data using a microphone while the user vocalizes the plurality of training sounds;
training an artificial intelligence network using the sensor data and the audio data to correlate speech pantomimes of the user with phonemes;
capturing a second set of sensor data with the array of distance measurement devices while the user pantomimes speech; and
generating phonemes from the second set of sensor data using the artificial intelligence network.

24. The method of claim 23, further comprising synthesizing speech from the phonemes.

25. The method of claim 23, wherein each of the distance measurement devices comprises a light emitter and an associated light sensor.

26. The method of claim 25, wherein each light emitter emits infrared light and its associated light sensor detects infrared light.

27. The method of claim 25, wherein each light emitter emits incoherent light.

28. The method of claim 23, wherein the headset frame comprises a first ear piece and a second earpiece, wherein the front frame portion extends between the first ear piece and the second earpiece.
